(19) United States
(12) Patent Application Publication
(10) Pub. No.: US 2016/0169805 A1
(43) Pub. Date: Jun. 16, 2016

(54) COMBINED RAMAN SPECTROSCOPY AND LASER-INDUCED BREAKDOWN SPECTROSCOPY

(71) Applicant: Thermo Scientific Portable Analytical Instruments Inc., Tewksbury, MA (US)

(72) Inventor: Peidong Wang, Carlisle, MA (US)

(21) Appl. No.: 14/571,420

(22) Filed: Dec. 16, 2014

(51) Int. Cl. G01N 21/65; G01N 21/71

(52) U.S. Cl. CPC G01N 21/65; G01N 21/718

(57) ABSTRACT

An apparatus includes a single laser source configurable to produce laser pulses directable towards a target substance, a focusing lens optically positionable between the single laser source and the target substance, the focusing lens focusing a first laser pulse to ablate at least a portion of the target substance when in a first focusing lens position to generate a plasma plume, the plume emitting atomic emission lines characteristic of elements including the target substance, the focusing lens focusing a second laser pulse in the target substance when in a second focusing lens position, resulting in Raman scattering, a collection optics assembly to detect signals representing the atomic emission lines characteristic of the target substance and the Raman scattering, and a spectrometer to detect signals received from the collection optics assembly.

### BACKGROUND

The invention generally relates to spectroscopy, and more specifically to combined Raman Spectroscopy and Laser-Induced Breakdown Spectroscopy.

Raman spectroscopy (RS) and Laser-Induced Breakdown Spectroscopy (LIBS) are complementary techniques developed, for example, to probe a surface of a sample. In general, LIBS uses a pulsed 1064-nm laser of high peak power (>1 GW/cm²) for ablating material from the surface of the sample to probe the elemental composition. RS uses either a continuous wave (CW) or a pulsed visible laser of modest average power (100-700 mW/cm²) to identify the molecular finger-prints of the sample from its Raman spectrum.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus for combined Raman Spectroscopy and Laser-Induced Breakdown Spectroscopy (LIBS).

In general, in one aspect, the invention features an apparatus including a single laser source configurable to produce laser pulses directable towards a target substance, a focusing lens optically positionable between the single laser source and the target substance, the focusing lens focusing a first laser pulse to ablate at least a portion of the target substance when in a first focusing lens position to generate a plasma plume, the plume emitting atomic emission lines characteristic of elements including the target substance, the focusing lens focusing a second laser pulse in the target substance when in a second focusing lens position, resulting in Raman scattering, a collection optics assembly to detect signals representing the atomic emission lines characteristic of the target substance and the Raman scattering, and a spectrometer to detect signals received from the collection optics assembly.

In another aspect, the invention features a method including, in an apparatus including a single laser source, a focusing lens and a spectrometer, moving the focusing lens to a first position between the single laser source and a target substance to ablate at least a portion of the target substance to generate a plasma plume, detecting with the spectrometer signals representing atomic emission lines characteristic of elements including the target substance, moving the focusing lens to a second position between the single laser source and the target substance to cause Raman scattering in the target substance, and detecting with the spectrometer signals representing Raman scattering in the target substance.

The present invention may include one or more of the following advantages.

An apparatus incorporates Raman spectroscopy (RS) and Laser-Induced Breakdown Spectroscopy (LIBS) in one instrument. In embodiments, the one instrument can be housed in a portable or handheld unit. With proper optics, the one instrument can analyze both elemental and molecular information on the materials under study.

An apparatus utilizes an optically positionable focusing lens. When the focusing lens is positioned to focus the laser beam on the sample, a plasma plume is generated and LIBS spectrographic measurements enabled. When the focusing lens is positioned to de-focus the laser beam on the sample, a Raman excitation is generated and Raman spectrographic measurements enabled.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a block diagram of an exemplary apparatus in accordance with the present invention.

FIG. 2 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In general, Raman spectroscopy typically uses either a continuous wave (CW) or a pulse visible laser of modest average power (e.g., approximately 100-700 mW/cm²) to identify a molecular fingerprint of a sample from its Raman spectrum.

In general, LIBS uses a pulsed laser having a typical wavelength of 1064 nm, and a high peak power (e.g., >1 GW/cm²) for ablating material from a surface of a sample and to probe elemental composition. During LIBS, a small amount of the target sample is ablated and atomized, and the resulting atoms are excited to emit light. The emitting elements are identified by their unique spectral peaks, and the process yields semi-quantitative abundances of major, minor, and trace elements, simultaneously.

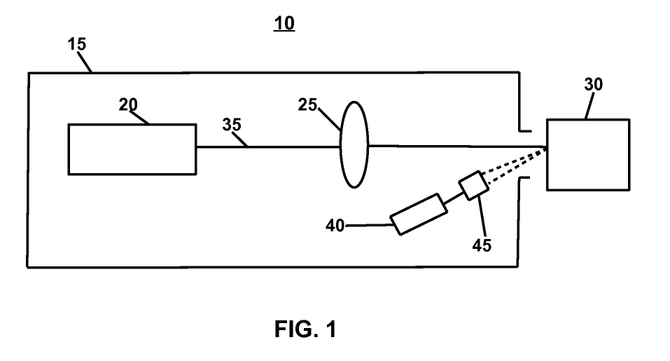

As shown in FIG. 1, an exemplary combined Raman spectroscopy and Laser-Induced Breakdown spectroscopy (LIBS) apparatus 10 includes a housing 15. The housing 15 can be manufactured from a variety of materials, such as a polymeric material or metal. In an embodiment, the housing 15 is sized to be portable. In still another embodiment, the housing 15 is sized to be handheld. The housing 15 includes a single laser source 20 and a re-positionable focusing lens 25 positionable in an optical path between the single laser source 20 and a sample 30 to be analyzed. The re-positionable focusing lens 25 can moved toward or away from the sample 30 using a simple gearing assembly (not shown) or other suitable positioning assembly. A laser beam 35 emitted from the single laser source 20 passes through the re-positionable focusing lens 25 and on to strike the sample 30. The optical path of laser beam 35 can include at least one mirror (not shown).

The housing 15 includes a single spectrometer 40 capable of processing one or more signals generated when the laser beam 35 strikes the sample 30 and collected at a collection optics assembly 45 (e.g., a collimator assembly), the one or more signals representing at least a Raman excitation or a LIBS plasma formation. Processing a Raman excitation in the spectrometer 40 is used to detect a molecular signature of the sample 30 while processing a LIBS plasma plume is used for elemental analysis of the sample 30.

The spectrometer 40 of the present invention operates in a range of 170-1050 nm, covering a traditional Si CCD range. More specifically, for the LIBS measurements, frequency harmonics of solid state lasers are used, such as 532 nm, 355 nm, 266 nm in the Nd:YAG, i.e., 1064 nm passive or active Q-switched lasers pumped with 808 nm semiconductor diode lasers. For example, the present invention uses laser pulses having an energy in a range of 1-20 mJ and a pulse width of 1-10 ns having a pulse repetition rate of up to 100 Hz. With proper optics, plasmas are generated and analyzed with the spectrometer 40 tuned in a 170 nm-450 nm range. Proper trigger and delay can be synchronized with the laser pulses in the signal acquisitions.

The above example uses 1064 nm as an example. To cover the harmonics of 532 nm, 355 nm, 266 nm, and so on, spectrometer 40 is still capable of doing both Raman and atomic emission spectroscopy. In the Raman case, one can detect Stokes shifted Raman signals using a standard Si CCD. For the 1064 nm Raman, a Si CCD can be used as a detector where the anti-Stokes Raman signal is detected. For the Stokes Raman (using 1064 nm), non-Si detectors can be used, such as InGaAs detectors, to cover the 1064-1700 nm range.

Thus, for LIBS spectrographic measurements conducted in the combined Raman spectroscopy and Laser-Induced Breakdown spectroscopy apparatus 10, the re-positionable focusing lens 25 is positioned to focus the laser beam 35 directly on the sample 30 and ablate at least a portion of the sample 30 to generate a detectable plasma plume. In particular, as the plasma plume expands and cools, the plume emits atomic emission lines characteristic of the sample 30.

For Raman spectroscopic measurements conducted in the combined Raman spectroscopy and Laser-Induced Breakdown spectroscopy apparatus 10, the re-positionable focusing lens 25 is moved away from a focus (i.e., de-focused) on the sample 30 to a second position using a simple gearing assembly so as not to create plasma on the sample surface. The re-positionable focusing lens 25 is moved away from a focus on the sample 30 so as to prevent generation of a detectable plasma plume. The resulting laser power is less than the power required to generate a plasma on the sample 30, but sufficient to conduct Raman spectroscopy. With frequency harmonics of 1064 nm, the combined Raman spectroscopy and Laser-Induced Breakdown spectroscopy apparatus 10 can directly use Raman Stokes excitations and improve the Raman efficiency as compared to the anti-Stokes Raman scattering. For example, for Stokes Raman scattering with 532 nm, the spectrometer 40 is tuned to the range of 533 nm-600 nm. Proper filters are implemented when conducting such Raman spectroscopy.

More specifically, the laser beam 35 passing through the re-positionable focusing lens 25 is of sufficient power to cause molecular vibrations or other excitations in the sample 30, resulting in Raman scattering in the sample 30 with the energy of the laser photons being shifted up or down. The shift in energy gives detectable information about the Raman active vibrational and rotational modes in the sample 30.

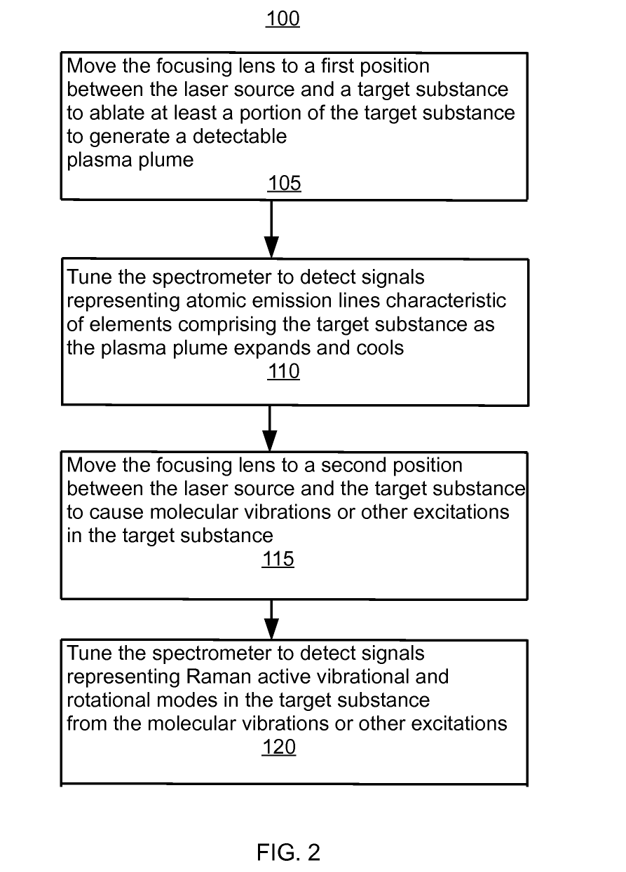

As shown in FIG. 2, a spectrographic process 100 includes, in an apparatus including a single laser source, a focusing lens and a spectrometer, moving (105) the focusing lens to a first position between the single laser source and a target substance to ablate at least a portion of the target substance to generate a detectable plasma plume.

The process 100 tunes (110) the spectrometer to detect atomic emission lines characteristic of elements including the target substance as the plasma plume expands and cools. In an embodiment, the spectrometer is tuned to a 170 nm-450 nm range to detect the atomic emission lines characteristic of the elements including the target substance.

The process 100 moves (115) the focusing lens to a second position between the single laser source and the target substance to cause molecular vibrations or other excitations in the target substance.

The process 100 tunes (120) the spectrometer to detect signals representing Raman scattering in the target substance resulting from Raman active vibrational and rotational modes in the target substance. In an embodiment, the spectrometer is tuned to a 800 nm-1063 nm range to detect the energy of laser photons being shifted up or down representing the Raman active vibrational and rotational modes in the target substance.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a single laser source configurable to produce laser pulses directable towards a target substance;
a focusing lens optically positionable between the single laser source and the target substance, the focusing lens focusing a first laser pulse to ablate at least a portion of the target substance when in a first focusing lens position to generate a plasma plume, the plume emitting atomic emission lines characteristic of elements comprising the target substance, the focusing lens focusing a second laser pulse in the target substance when in a second focusing lens position, resulting in Raman scattering;
a collection optics assembly to detect signals representing the atomic emission lines characteristic of the target substance and the Raman scattering; and
a spectrometer to detect signals received from the collection optics assembly.

2. The apparatus of claim 1 wherein the single laser source produces laser pulses having an energy of 1-20 mJ and a pulse width of 1-10 ns for a pulse repetition rate of up to 100 Hz.

3. The apparatus of claim 1 wherein the spectrometer is configured to operate in a range of 170-1050 nm.

4. The apparatus of claim 1 wherein the spectrometer is tuned to a 170 nm-450 nm range to detect the atomic emission lines characteristic of the elements comprising the target substance.

5. The apparatus of claim 1 wherein the spectrometer is tuned to a 800 nm-1063 nm range to detect Raman scattering in the target substance.

6. The apparatus of claim 1 wherein the first focusing lens position causes the first laser pulse to be focused on the target substance.

7. The apparatus of claim 1 wherein the second focusing lens position causes the second laser pulse to be de-focused on the target so as to prevent generation of the detectable plasma plume.

8. A method comprising:
in an apparatus comprising a single laser source, a focusing lens and a spectrometer, moving the focusing lens to a first position between the single laser source and a target substance to ablate at least a portion of the target substance to generate a plasma plume;
detecting with the spectrometer signals representing atomic emission lines characteristic of elements comprising the target substance;
moving the focusing lens to a second position between the single laser source and the target substance to cause Raman scattering in the target substance; and
detecting with the spectrometer signals representing Raman scattering in the target substance.

9. The method of claim 8 wherein the spectrometer is tuned to a 170 nm-450 nm range to detect the atomic emission lines characteristic of the elements comprising the target substance.

10. The method of claim 8 wherein the spectrometer is tuned to a 800 nm-1063 nm range to detect Raman scattering in the target substance.
